(19) United States
(12) Patent Application Publication
(10) Pub. No.: US 2005/0075876 A1
(43) Pub. Date: Apr. 7, 2005

(54) Continuous speech recognition apparatus, continuous speech recognition method, continuous speech recognition program, and program recording medium

(76) Inventor: Akira Tsuruta, Nara (JP)

Correspondence Address: BIRCH STEWART KOLASCH & BIRCH, PO BOX 747, FALLS CHURCH, VA, 22040-0747, US

(21) Appl. No.: 10/501,502

(22) PCT Filed: Dec. 13, 2002
(86) PCT No.: PCT/JP02/13053

(30) Foreign Application Priority Data
Jan. 16, 2002 (JP) 2002-007283

(51) Int. Cl. G10L 15/18; G10L 15/04

(52) U.S. Cl. 704/251; 704/257

(57) ABSTRACT

Accuracy is assured by using phoneme context dependent acoustic models even at word boundaries and also time increase of a processing amount is suppressed even in large-vocabulary continuous speech recognition. A phoneme context dependent acoustic model storage unit contains phoneme state trees in each of which state sequences each consisting of a preceding phoneme state, a center phoneme state, and a succeeding phoneme state are configured in a tree structure with triphone models with the same preceding phoneme and triphone models with the same center phoneme collected. Accordingly, a forward matching unit has only to develop one phonemic hypothesis regardless of a leading phoneme of the succeeding word, by referencing the phoneme state trees, language models stored in a language model storage unit, and a word lexicon. Thus, development of hypotheses is easy regardless of in-word or word-boundary state. Moreover, an operation amount in performing matching with feature parameter sequences from an acoustic analysis unit can be remarkably reduced.

This application is the US national phase of International Application PCT/JP02/13053 filed Dec. 13, 2002, which designated the US. PCT/JP02/13053 claims priority to JP Patent Application No. 2002-007283 filed Jan. 16, 2002. The entire contents of these applications are incorporated therein by reference.

### TECHNICAL FIELD

The present invention relates to a continuous speech recognition apparatus, a continuous speech recognition method and a continuous speech recognition program for performing high accuracy recognition by using the phoneme context dependent acoustic model, and a program recording medium containing the continuous speech recognition program.

### BACKGROUND ART

Generally, as recognition units for use in large vocabulary continuous speech recognition, recognition units called sub-words such as syllables and phonemes, which are smaller units than words, are often used because they facilitate change of recognition target vocabulary and extension thereof to large vocabulary. Further, it is known that environment (i.e. context) dependent models are effective to take the influence of coarticulation and the like into consideration. For example, a phoneme model called a triphone model that depends on one preceding phoneme and one succeeding phoneme is widely used.

Moreover, continuous speech recognition methods for recognizing continuously issued speech include a method for obtaining recognition results by concatenating each word in the vocabulary based on a sub-word transcription dictionary in which words are described in the form of a sub-word network or tree structure, and grammar defining constraints on connection of words or information on the statistical language model.

These continuous speech recognition technologies using sub-words as recognition units are described in detail in, for example, a publication titled “Fundamentals of Speech Recognition” translation supervised by Sadaoki FURUI.

As described above, in the case of performing continuous speech recognition using context-dependent sub-words, it is known that phoneme context dependent acoustic model should be used not only within a word but also in between the words so as to achieve higher recognition accuracy. However, the acoustic model used at the beginning and end portions of a word is dependent on preceding and succeeding words, which complicates the processing and causes significant increase of the processing amount compared to the case of using the acoustic model independent from phoneme context.

Hereinbelow, detailed description will be given of a method for dynamic generation of a tree for every word history with reference to the word lexicon, the language model and the phoneme context dependent acoustic model.

For example, in the case of considering the last phoneme /a/ of a word “ [symbol] (a;s;a)” (which means “morning”) in the speech of “ [symbol] [symbol] asanotenki . . . ” (which means “weather of morning . . . ”), it is necessary to develop hypotheses about a triphone “s;a;h” consisting of the third phoneme /a/ in a word “ [symbol] [symbol] (a;s;a;h;i)” (which means “morning light”) and the preceding and succeeding phonemes obtained from the information in the word lexicon shown in FIG. 3, and a triphone “s;a;n” consisting of the third phoneme /a/ in a combination “ [symbol] [symbol] (a;s;a;n;o)” of a word “ [symbol] (n;o)” (which means “of”) and the preceding word “ [symbol] (a;s;a)” (which means “morning”) obtained from the information in the language model shown in FIG. 4, and the preceding and succeeding phonemes. Although only two hypotheses should be developed in this example, the end portion of a word may be connectable to a larger number of words in the case of using more complicated grammar and statistical language model. In such a case, depending on the leading phonemes of these words, a number of hypotheses should be developed as shown in FIG. 5B with use of, for example, the state sequences of triphones consisting of preceding phonemes, center phonemes and succeeding phonemes as shown in FIG. 2B.

In order to solve this problem, JP 05-224692 A teaches a continuous speech recognition method in which the phoneme context dependent acoustic model is used within a word while the context independent acoustic model is used at the word boundary. According to the continuous speech recognition method, increase of the processing amount in between the words may be suppressed. Moreover, JP 11-45097 A teaches a continuous speech recognition method in which for each word in the recognition target vocabulary, matching is done by using a recognition word lexicon which describes acoustic model series determined independent of preceding and succeeding words as recognition words and an intermediate word lexicon which describes acoustic model series depending on the preceding and succeeding words at the word boundary as intermediate words. According to the continuous speech recognition method, even with use of the phoneme context dependent acoustic model at the word boundary, increase of the processing amount may be suppressed.

However, the above-mentioned conventional continuous speech recognition methods have the following problems. More particularly, in the continuous speech recognition method disclosed in JP 05-224692 A, the phoneme context dependent acoustic model is used within a word while the phoneme context independent acoustic model is used at the word boundary. This makes it possible to suppress increase of the processing amount at the word boundary but at the same time may cause deterioration of the recognition performance particularly in the case of the large vocabulary continuous speech recognition since the acoustic model for use at the word boundary is low in accuracy.

In the continuous speech recognition method disclosed in JP 11-45097 A, matching is executed by using the recognition word lexicon which describes acoustic model series determined independent from preceding and succeeding words as recognition words and an intermediate word lexicon which describes acoustic model series dependent on the preceding and succeeding words at the word boundary. This makes it possible to suppress the processing amount at the word boundary even in the case of processing large vocabulary while assuring accuracy by using the phoneme context dependent acoustic model also at the word boundary. However, the score and boundary of a word are generally influenced by the preceding words. Consequently, if a plurality of recognition words share an intermediate word (i.e. a word between words), boundaries between recognition words “k;o;k” and “s;o;k” and an intermediate word “o” are not taken into consideration as shown in FIG. 9A, which may cause deterioration of the performance compared to the case of taking the history of the word boundaries into consideration as shown in FIG. 9B. Moreover, no disclosure is found as for words such as a postpositional particle “ [symbol] (pronounced as /o/)” which cannot be classified into the recognition word lexicon and the intermediate word lexicon.

### SUMMARY OF THE INVENTION

Accordingly, it is a feature of the present invention to provide a continuous speech recognition apparatus, a continuous speech recognition method and a continuous speech recognition program that are capable of suppressing increase of the processing amount at the word boundaries even during large vocabulary continuous speech recognition while assuring accuracy by using the phoneme context dependent acoustic model even at the word boundaries, and also to provide a program recording medium containing such a continuous speech recognition program.

In order to accomplish the above feature, the present invention provides a continuous speech recognition apparatus which uses, as a recognition unit, a sub-word determined depending on an adjacent sub-word and which uses context dependent acoustic models dependent on sub-word context to recognize a continuous input speech, comprising an acoustic analysis section analyzing the input speech to obtain feature parameter time series; a word lexicon in which each of words included in vocabulary is stored in a form of a sub-word network or in a sub-word tree structure; a language model storage unit in which language models representing information regarding connection between words is stored; a context dependent acoustic model storage unit in which the context dependent acoustic models are stored in a form of sub-word state trees in each of which state sequences of a plurality of sub-word models of the context dependent acoustic models are organized in a tree structure; a matching unit developing hypotheses of sub-words by referencing the sub-word state tree representing the context dependent acoustic models, the word lexicon and the language models, and performing matching between the feature parameter time series and the developed hypotheses so as to output, as a word lattice, word information including a word, an accumulated score and a beginning start frame with respect to a hypothesis representing a word end portion; and a search unit for searching the word lattice to generate recognition results.

According to the above constitution, sub-word hypotheses are developed by referring to the sub-word state trees formed by placing the context dependent acoustic models dependent on the sub-word context in a tree structure, the word lexicon and the language model. Therefore, what is necessary is only to develop one hypothesis regardless of a head or leading sub-word of the next word, which allows drastic decrease of a total number of states in all the hypotheses. More specifically, it becomes possible to significantly reduce the hypothesis developing amount and easily develop hypotheses regardless of in-word or word-boundary state. Further, the matching unit allows significant reduction of the amount of operation when the feature parameter series from the acoustic analysis section are matched with the developed hypotheses.

In one embodiment, the context dependent acoustic models stored in the context dependent acoustic model storage unit (3) are context dependent acoustic models in which a center sub-word depends on sub-words preceding and succeeding the center sub-word respectively, and the state sequences of sub-word models having identical preceding sub-words and identical center sub-words are organized in a tree structure.

According to this embodiment, the hypotheses are developed by using the sub-word state trees formed by placing the state sequences of the sub-word models having the same preceding sub-word and the same center sub-word in a tree structure. Therefore, when developing the next hypothesis, attention should be paid only to a center sub-word in the preceding or end hypothesis and a sub-word state tree having a corresponding preceding sub-word should be developed. More precisely, even with the presence of a multiplicity of succeeding sub-words, the number of hypotheses to be developed can be smaller, so that the hypotheses can be developed easily.

In one embodiment, the context dependent acoustic models are state sharing models in which a plurality of sub-word models share states.

According to this embodiment, state sharing by a plurality of sub-word models makes it possible to combine the shared states together when placed in a tree structure, thereby allowing decrease of the number of nodes. Therefore, the processing amount during matching operation by the matching unit can be reduced significantly.

In one embodiment, when developing the hypotheses by referencing the sub-word state tree, the matching unit puts a flag on states connectable to each other in the sub-word state trees that represent the hypotheses, by using information on connectable sub-words obtained from the word lexicon and the language model.

According to this embodiment, of the states in the sub-word state tree constituting the developed hypothesis, states connectable to each other are flagged. This limits the states that require Viterbi calculation during matching operation, thereby allowing further decrease of the matching amount.

In one embodiment, during a matching operation, the matching unit calculates scores of the developed hypotheses based on the feature parameter time series, and prunes the hypotheses in conformity to criteria including a threshold value of the scores or a quantity of hypotheses.

According to this embodiment, the hypothesis pruning is performed during the matching operation, so that hypotheses with low likelihood to be a word or words are deleted, which allows significant reduction of the following matching operation amount.

The present invention also provides a continuous speech recognition method which uses, as a recognition unit, a sub-word determined depending on an adjacent sub-word and which uses context dependent acoustic models dependent on sub-word context to recognize a continuous input speech, comprising analyzing the input speech to obtain feature parameter time series by an acoustic analysis section; developing hypotheses of sub-words by referencing a sub-word state tree formed by placing state sequences of the context dependent acoustic models in a tree structure, a word lexicon describing each of words included in vocabulary in a form of a sub-word network or in a sub-word tree structure, and a language model representing information regarding connection between words, and performing matching between the feature parameter time series and the developed hypotheses so as to generate, as a word lattice, word information including a word, an accumulated score and a beginning start frame with respect to a hypothesis regarding a word end portion, by a matching unit; and searching the word lattice to generate recognition results by a search unit.

According to the above constitution, as with the case of the continuous speech recognition apparatus of the invention, hypotheses are developed by referring to the sub-word state tree formed by placing the context dependent acoustic models in a tree structure. Therefore, what is necessary is only to develop one hypothesis regardless of the head sub-word of the succeeding word, which makes it possible to easily develop hypotheses regardless of in-word or word-boundary state. Further, the amount of matching operation to be done for matching between the feature parameter series and the developed hypotheses is significantly reduced.

A continuous speech recognition program according to the present invention makes a computer function as the acoustic analysis section, the word lexicon, the language model storage unit, the context dependent acoustic model storage unit, the matching unit, and the search unit in the continuous speech recognition device of the present invention.

According to the above constitution, as with the case of the continuous speech recognition apparatus of the invention, only one hypothesis may be developed regardless of the leading sub-word of the succeeding word, which makes it possible to easily develop hypotheses regardless of in-word or word-boundary state. Further, the amount of matching operation to be done for matching between the feature parameter series and the developed hypotheses is significantly reduced.

A program recording medium according to the present invention has the continuous speech recognition program of the present invention stored therein.

According to the above constitution, as with the case of the continuous speech recognition apparatus of the invention, only one hypothesis may be developed regardless of the leading sub-word of the succeeding word, which makes it possible to easily develop hypotheses regardless of in-word or word-boundary state. Further, the amount of matching operation to be done for matching between the feature parameter series and the developed hypotheses is significantly reduced.

### BRIEF DESCRIPTION OF THE DRAWINGS

FIG. 1 is a block diagram of a continuous speech recognition apparatus according to the present invention;

FIG. 2A and FIG. 2B are explanatory diagrams showing phoneme context dependent acoustic models;

FIG. 3 is an explanatory diagram showing a word lexicon shown in FIG. 1;

FIG. 4 is an explanatory diagram showing a language model;

FIG. 5A and FIG. 5B are explanatory diagrams showing hypotheses developed by a forward matching section shown in FIG. 1;

FIG. 6 is a flowchart showing a forward matching operation executed by the forward matching section;

FIG. 7A and FIG. 7B are explanatory diagrams showing matching and pruning of hypotheses by the forward matching section;

FIG. 8 is an explanatory diagram showing that a flag is put only on the necessary states in a phoneme state tree of phonemic hypotheses; and

FIGS. 9A and 9B are diagrams for comparison between the case without consideration of the history of boundaries between a recognition word and an intermediate word and the case with consideration thereof.

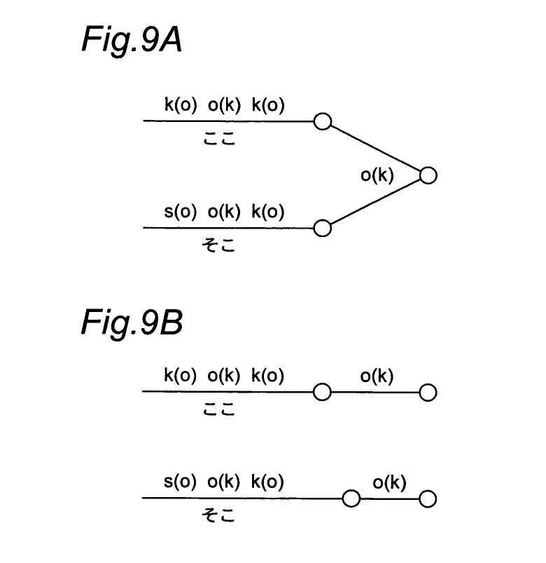

### DETAILED DESCRIPTION

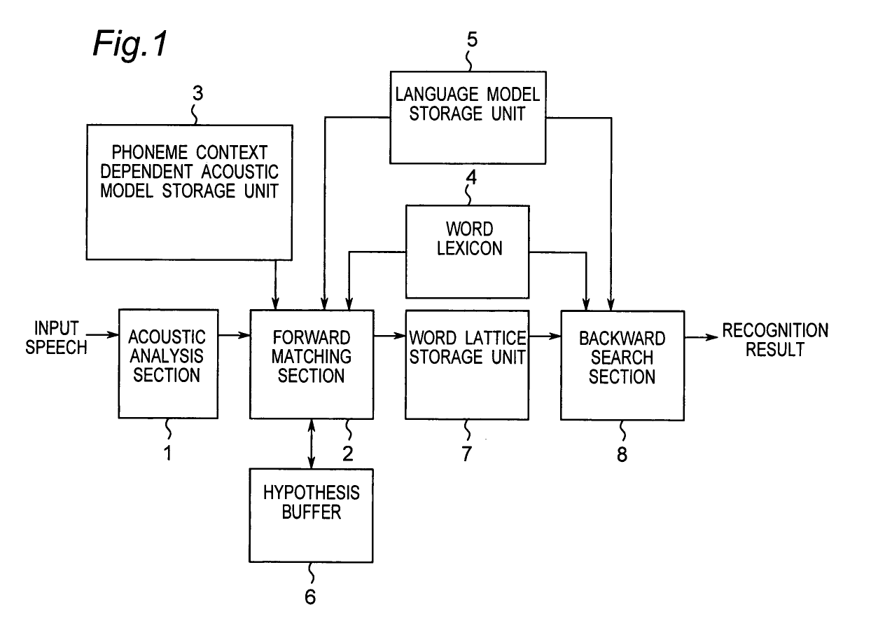

Embodiments of the invention will now be described in detail with reference to the accompanying drawings. FIG. 1 is a block diagram showing a continuous speech recognition apparatus in this embodiment. The continuous speech recognition apparatus has an acoustic analysis section 1, a forward matching section 2, a phoneme context dependent acoustic model storage unit 3, a word lexicon 4, a language model storage unit 5, a hypothesis buffer 6, a word lattice storage unit 7, and a backward search section 8.

In FIG. 1, the acoustic analysis section 1 converts an input speech to a feature parameter sequence and supplies it to the forward matching section 2. The forward matching section 2 develops phonemic hypotheses on the hypothesis buffer 6 by referencing the phoneme context dependent acoustic model stored in the phoneme context dependent acoustic model storage unit 3, the language model stored in the language model storage unit 5 and the word lexicon 4. Then, with use of the phoneme context dependent acoustic model, matching between the developed phonemic hypotheses and the feature parameter series is performed through a frame synchronizing Viterbi beam search to produce a word lattice, which is stored in the word lattice storage unit 7.

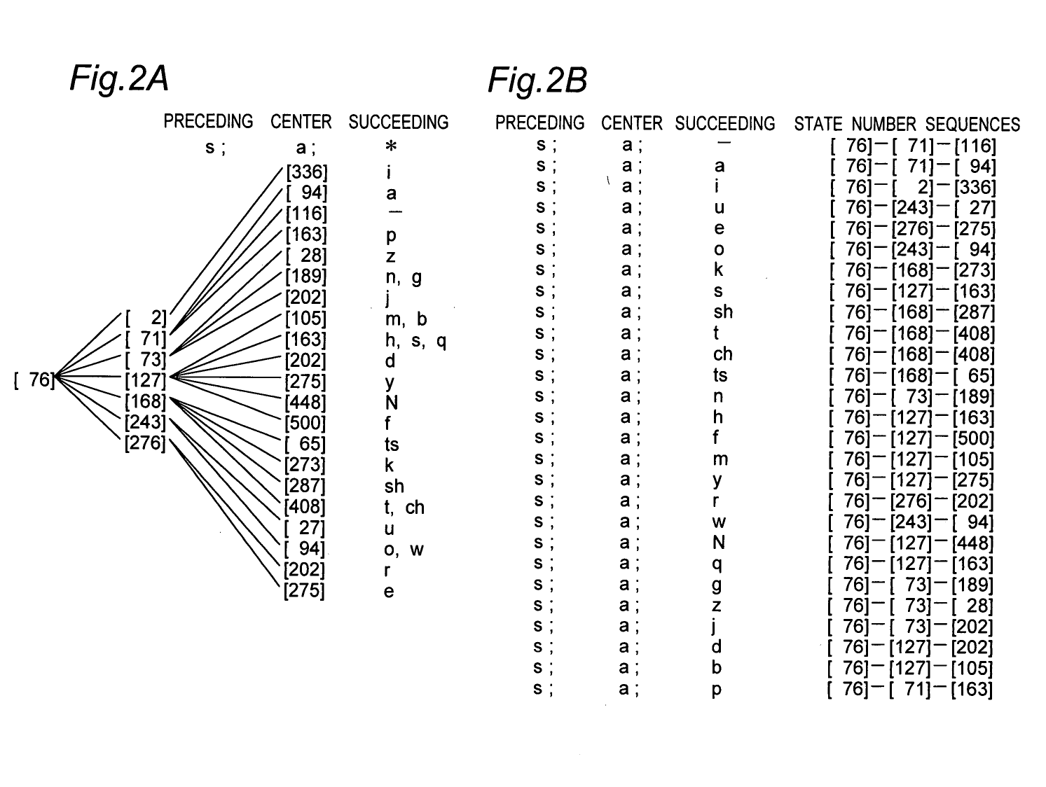

Used as the phoneme context dependent acoustic model is a Hidden Markov Model (HMM) called a triphone model which takes the environment of one preceding phoneme and one succeeding phoneme into consideration. More specifically, the sub-word model is a phoneme model. It is to be noted that as shown in FIG. 2B, a triphone model that takes one preceding phoneme and one succeeding phoneme of a center phoneme into consideration is conventionally expressed in the form of a state sequence consisting of three states (state number sequence), but in the present embodiment, as shown in FIG. 2A, state sequences of triphone models having the same preceding phoneme and the same center phoneme are collected and placed in a tree structure (hereinbelow referred to as phoneme state tree). As shown in FIG. 2A, the state sharing model, in which a plurality of triphone models share states, allows reduction of the number of states by placing the state sequences into a tree structure to form the phoneme state tree, and therefore the calculation amount can be decreased.

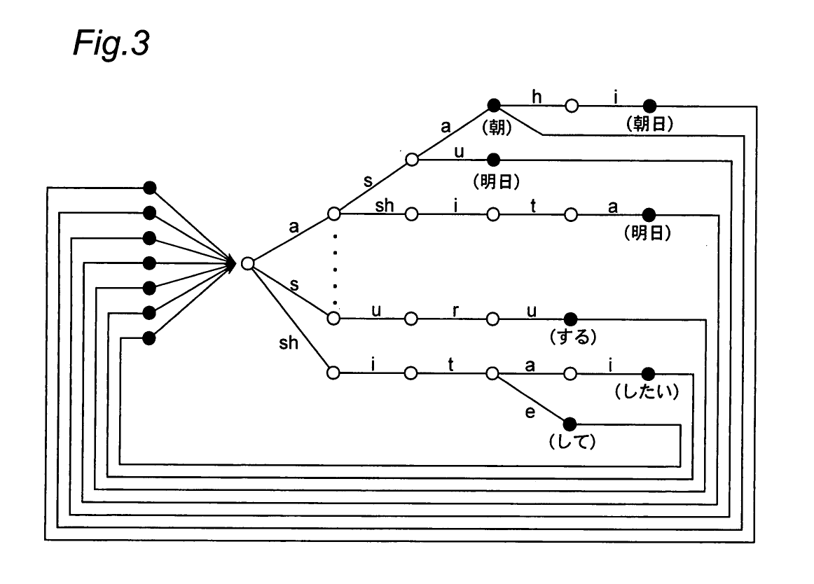

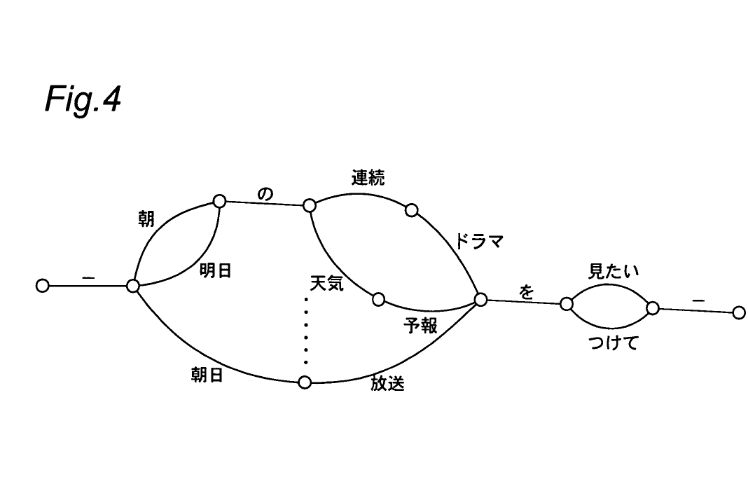

Used as the word lexicon 4 is a dictionary in which each of the words in recognition target vocabulary is described as phoneme sequences, which are formed in a tree structure as shown in FIG. 3. In the language model storage unit 5, for example as shown in FIG. 4, information on intermediate word connection set by grammar is stored as a language model. It is to be noted that in the present embodiment, the phoneme sequences representing pronunciations of the words which are placed in a tree structure serve as the word lexicon 4. However, the phoneme sequences in the form of a network are also acceptable. Moreover, although a grammar model is applied as the language model, a statistical language model is also applicable.

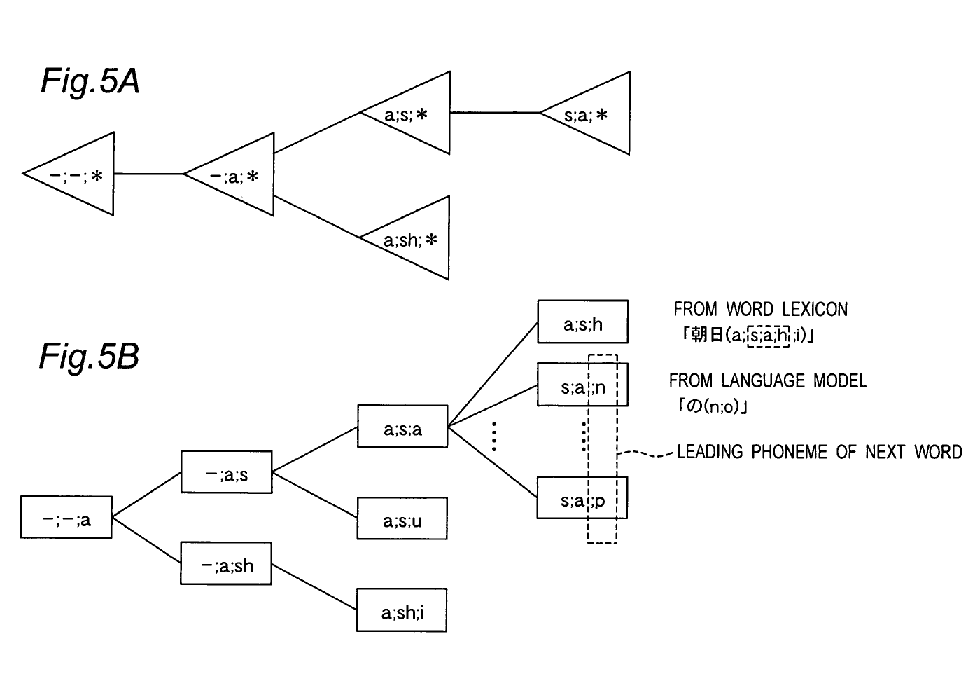

On the hypothesis buffer 6, as described above, phonemic hypotheses are developed in sequence as shown in FIG. 5A by the forward matching section 2 referring to the phoneme context dependent acoustic model storage unit 3, the word lexicon 4 and the language model storage unit 5. The backward search section 8 searches for a word lattice stored in the word lattice storage unit 7 with use of, for example, A* algorithm while referring to the language model stored in the language model storage unit 5 and the word lexicon 4 so as to obtain a recognition result of the input speech.

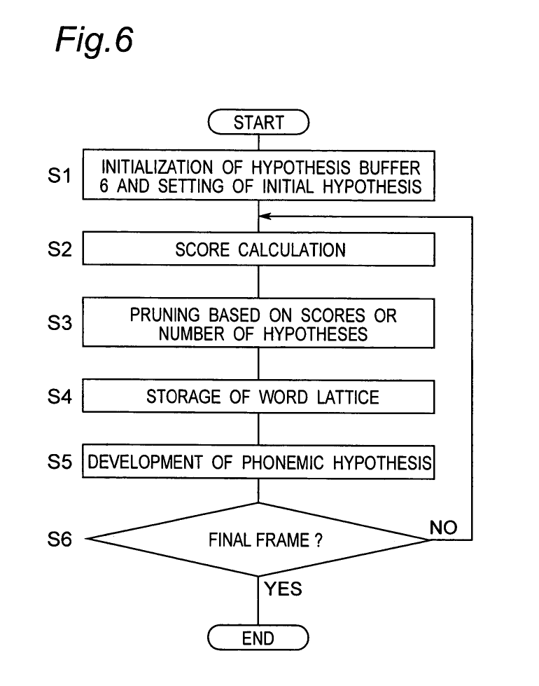

Hereinbelow, by using a forward matching operation flowchart shown in FIG. 6, description will be given of a method by which the forward matching section 2 develops hypotheses on the hypothesis buffer 6 with reference to the phoneme context dependent acoustic model storage unit 3, the word lexicon 4, and the language model storage unit 5 to produce a word lattice.

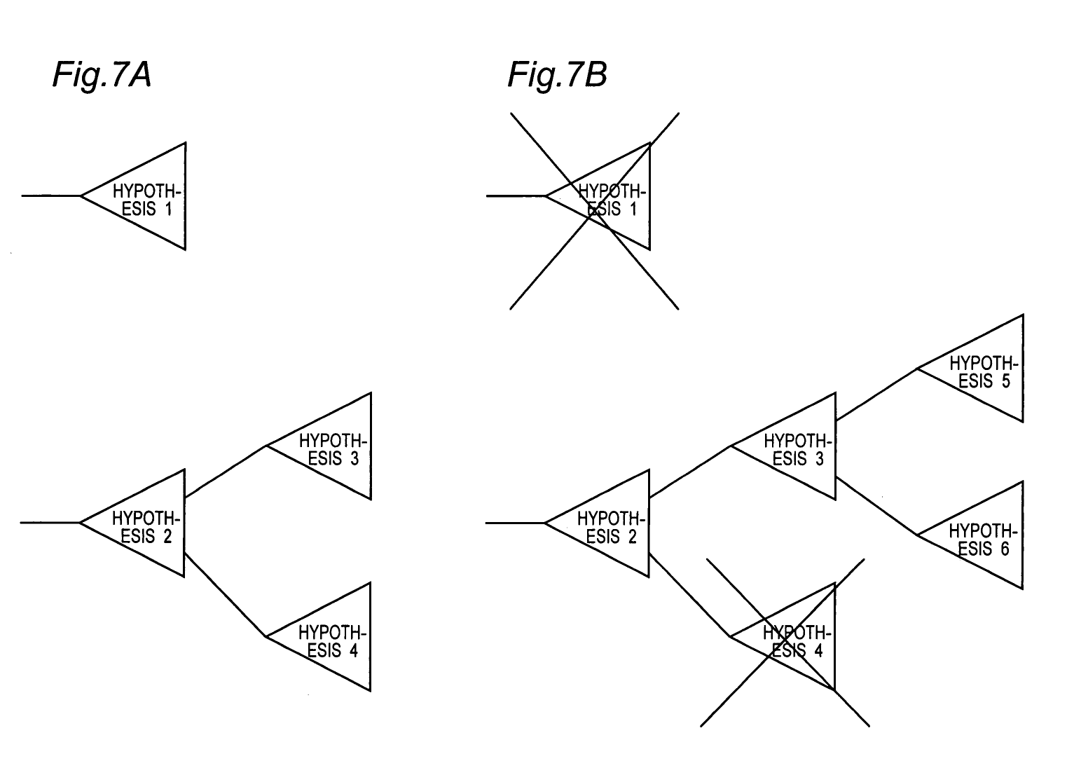

In step Si, first, the hypothesis buffer 6 is initialized before matching operation is started. Then, a phoneme state tree consisting of “-;-;*” starting from silence and ending at the beginning portion of each word is set on the hypothesis buffer 6 as an initial hypothesis. In step S2, the phoneme context dependent acoustic model is applied to perform matching between feature parameters in a processing target frame and phonemic hypotheses in the hypothesis buffer 6 as shown in FIG. 7A, and a score of each phonemic hypothesis is calculated. In step S3, as shown in FIG. 7B, pruning of the phoneme hypothesis is performed, as is the case of hypothesis 1 and hypothesis 4, based on a threshold of the score, the number of hypotheses, or the like. Thus, unnecessary increase in number of the phonemic hypotheses is prevented. In step S4, word information including a word, an accumulated score and a beginning start frame regarding the phonemic hypotheses remaining in the hypothesis buffer 6 and having an active end portion of the word is stored in the word lattice storage unit 7. In this way, a word lattice is produced and saved. In step S5, as is hypothesis 5 and hypothesis 6 shown in FIG. 7B, the phonemic hypotheses remaining in the hypothesis buffer 6 are presented by referencing information in the phoneme context dependent acoustic model storage unit 3, the word lexicon 4 and the language model storage unit 5. In step S6, it is determined whether or not a processing target frame is a final frame. As a result, if it is the final frame, then the forward matching operation is ended. If it is not the final frame, then the procedure returns to the step S2 and moves to the next frame processing. From then on, the step 2 to step 6 are repeated, and when it is determined that a frame is the final frame in the step S6, the forward matching operation is ended.

Hereinbelow, description will be made of the effect and advantage achieved when a phoneme state tree formed by placing the state sequences of triphone models having the same preceding phoneme and center phoneme in a tree structure is used during the forward matching operation.

For example, in the case of considering the last phoneme /a/ of a word “ [symbol] (a;s;a)” (which means “morning”) in the speech of “ [symbol] [symbol] asanotenki . . . ” (which means “weather of morning . . . ”), it is possible to develop hypotheses about a triphone “s;a;h” consisting of the third phoneme /a/ in a word “ [symbol] [symbol] (a;s;a;h;i)” (which means “morning light”) and the preceding and the succeeding phonemes obtained from the information in the word lexicon 4 shown in FIG. 3, and a triphone “s;a;n” consisting of the third phoneme /a/ in a combination “ [symbol] [symbol] a;s;a;n;o” of a word “ [symbol] (n;o)” (which means “of”) and the preceding word “ [symbol] (a;s;a)” (which means “morning”) obtained from the information in the language model shown in FIG. 4, and the phonemes preceding and succeeding the third phoneme /a/. Although only two hypotheses should be developed in this example, the end portion of a word may be connectable to a larger number of words in the case of using more complicated grammar and statistical language model. In such a case, depending on the leading phonemes of the next words, a number of hypotheses should be developed as shown in FIG. 5B. In contrast, in the case of developing phonemic hypotheses in the phoneme state tree like the present embodiment, what is necessary is only to develop one phoneme state tree “s;a;*” of FIG. 2A, as shown in FIG. 5A, regardless of the leading phonemes of the next words. It is to be noted that in FIG. 5A, a triangle imitating “a tree” is used as a symbol of the phoneme state tree.

As shown in FIG. 5B, in the case of developing hypotheses for respective phonemes, assuming that the succeeding words have a total of 27 kinds of leading phonemes, the number of newly developed phonemic hypotheses is 27, and the total number of the states in all the newly developed phonemic hypotheses amounts to 81 (=27×3).

In contrast to the above, as shown in FIG. 5A, by developing phonemic hypotheses with use of the phoneme state tree, the number of phonemic hypotheses to be newly developed is 1, and the total number of the states can be reduced to 29 (1+7+21). Therefore, it becomes possible to significantly reduce the processing amount of hypothesis developing operation and matching operation.

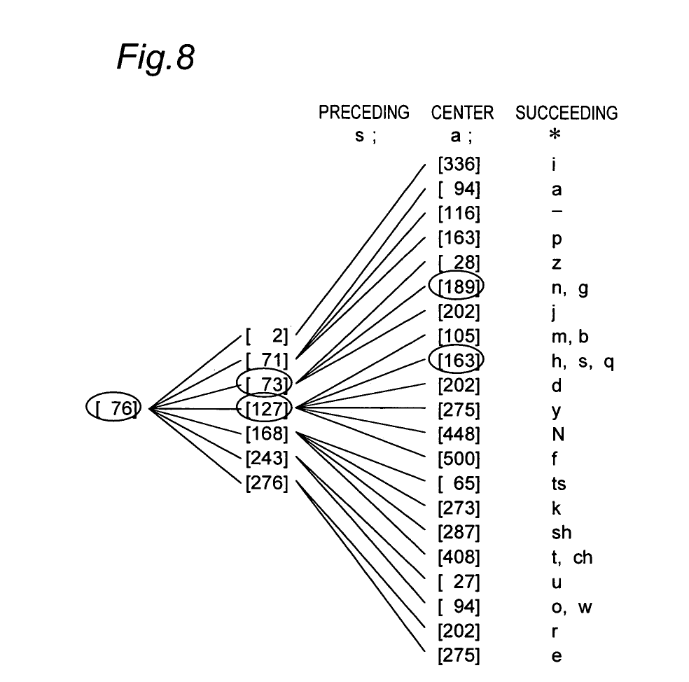

Moreover, in the case of applying grammar to the language model, the succeeding or subsequent phonemes are often limited by the word lexicon 4 and the language model. Accordingly, as shown in FIG. 8, a flag (an oval figure in FIG. 8) is put only on the states that are necessary for a phoneme sequence “s;a;h” based on the word lexicon 4 and a phoneme sequence “s;a;n” based on the language model, among all the states in the phoneme state tree “s;a;*”, so that a total number of states to be matched is reduced to five, as compared with the total state number of 29 in the phoneme state tree “s;a;*”. Therefore, the matching amount may further be reduced.

As described above, in the present embodiment, the phoneme state tree formed by placing the state sequences of triphone models in a tree structure with triphone models having the same preceding phoneme and center phoneme collected is stored in the phoneme context dependent acoustic model storage unit 3. As a result, in the case of the state sharing models in which a plurality of triphone models share the states, the shared states can be combined when placed in a tree structure, thereby making it possible to decrease the number of nodes. Therefore, in developing hypotheses for every phoneme, with the phoneme state trees used as phonemic hypotheses, what is necessary is to develop only one phoneme hypothesis regardless of a leading or head phoneme of the succeeding word. In the conventional case, on the assumption that the succeeding word has a total of 27 kinds of head phonemes, 27 phonemic hypotheses are newly developed and therefore all the phonemic hypotheses amounts to 81 states. In contrast to this, in the present embodiment, only one phoneme hypothesis is newly developed, so that the total number of states can be reduced to 29.

That is, accordingly to the present invention, it becomes possible to significantly reduce the amount of phonemic hypothesis development performed by the forward matching section 2 with reference to the phoneme context dependent acoustic model stored in the phoneme context dependent acoustic model storage unit 3, the language model stored in the language model storage unit 5 and the word lexicon 4. Therefore, it becomes possible to easily develop the hypotheses regardless of in-word and word-boundary states. Further, it becomes possible to significantly reduce the amount of matching operation that is performed by the forward matching section 2 to match the feature parameter sequences from the acoustic analysis section 1 with the developed phonemic hypotheses by frame synchronizing Viterbi beam search with use of the phoneme context dependent acoustic model.

In that case, during the matching operation of the phonemic hypotheses, the matching unit 2 calculates scores of each developed hypothesis, and prunes phonemic hypotheses in conformity to a threshold value of the scores or a threshold value of the hypothesis quantity. Therefore, hypotheses with low likelihood to be a word can be deleted, which allows significant reduction of the matching operation amount. Further, by referencing the language model storage unit 5 and the word lexicon 4 during developing the phonemic hypotheses, the forward matching section 2 may put the flag only on those states, in the sub-word state tree constituting the developed hypotheses, that are connectable to each other and that concern the matching operation. Therefore, in this case, Viterbi calculation is not necessary for the states in the tree structure that do not concern the matching operation, thereby allowing further reduction of the matching operation amount.

It is to be noted that in the above description, used as the phoneme context dependent acoustic model is an HMM called a triphone model which takes the context of one preceding and one succeeding phonemes into consideration. However, a sub-word determined depending on adjacent sub-words are not limited thereto.

Functions as the acoustic analysis means, the matching means and the search means of the acoustic analysis section 1, the forward matching section 2 and the backward search section 8, respectively, in the aforementioned embodiment are implemented by a continuous speech recognition program recorded onto a program recording medium. The program recording medium in the embodiment is a program medium composed of a ROM (Read Only Memory) provided separately from a RAM (Random Access Memory). Alternatively, the program medium may be the one that is mounted on an external auxiliary storage unit and is read therefrom. In either case, a program read means for reading the continuous speech recognition program from the program medium may be structured to read the program through direct access to the program medium, or may be structured to download the program to a program storage area (unshown) of the RAM and to read the downloaded program through access to the program storage area. It is to be noted that a download program for downloading the continuous speech recognition program from the program medium to the program storage area of the RAM is preinstalled in a main unit.

The program media herein refer to media that are structured detachably from a main unit and that hold a program in a fixed manner, including: tapes such as magnetic tapes and cartridge tapes; discs such as magnetic discs including floppy discs and hard discs, and optical discs such as CD (Compact Disc)-ROMs, MO (Magneto Optical) discs, MDs (Mini Discs) and DVDs (Digital Versatile Discs); cards such as IC (Integrated Circuit) cards and optical cards; and semiconductor memories such as mask ROMs, EPROMs (ultraviolet-Erasable Programmable Read Only Memories), EEPROMs (Electronically Erasable and Programmable Read Only Memories) and flash ROMs.

Further, in the case where the continuous speech recognition apparatus in the aforementioned embodiment is provided with a modem and structured connectable to communication networks including Internet, the program medium may be a medium holding a program in a fluid manner through downloading of the program from communication networks or the like. In such a case, a download program for downloading the program from the communication networks may be preinstalled in the main unit or installed from another recording medium.

It should be understood that without being limited to the program, contents to be recorded on the recording media may include data.

1. A continuous speech recognition apparatus which uses, as a recognition unit, a sub-word determined depending on an adjacent sub-word and which uses context dependent acoustic models dependent on sub-word context to recognize a continuous input speech, comprising:
an acoustic analysis section analyzing the input speech to obtain feature parameter time series;
a word lexicon in which each of words included in vocabulary is stored in a form of a sub-word network or in a sub-word tree structure;
a language model storage unit in which language models representing information regarding connection between words is stored;
a context dependent acoustic model storage unit in which the context dependent acoustic models are stored in a form of sub-word state trees in each of which state sequences of a plurality of sub-word models of the context dependent acoustic models are organized in a tree structure;
a matching unit developing hypotheses of sub-words by referencing the sub-word state tree representing the context dependent acoustic models, the word lexicon and the language models, and performing matching between the feature parameter time series and the developed hypotheses so as to output, as a word lattice, word information including a word, an accumulated score and a beginning start frame with respect to a hypothesis representing a word end portion; and
a search unit for searching the word lattice to generate recognition results.

2. The continuous speech recognition apparatus as defined in claim 1, wherein
the context dependent acoustic models stored in the context dependent acoustic model storage unit are context dependent acoustic models in which a center sub-word depends on sub-words preceding and succeeding the center sub-word respectively, and the state sequences of sub-word models having identical preceding sub-words and identical center sub-words are organized in a tree structure.

3. The continuous speech recognition apparatus as defined in claim 2, wherein
the context dependent acoustic models are state sharing models in which a plurality of sub-word models share states.

4. The continuous speech recognition apparatus as defined in claim 1, wherein
when developing the hypotheses by referencing the sub-word state tree, the matching unit puts a flag on states connectable to each other in the sub-word state trees that represent the hypotheses, by using information on connectable sub-words obtained from the word lexicon and the language model.

5. The continuous speech recognition apparatus as defined in claim 1, wherein
during a matching operation, the matching unit calculates scores of the developed hypotheses based on the feature parameter time series, and prunes the hypotheses in conformity to criteria including a threshold value of the scores or a quantity of hypotheses.

6. A continuous speech recognition method which uses, as a recognition unit, a sub-word determined depending on an adjacent sub-word and which uses context dependent acoustic models dependent on sub-word context to recognize a continuous input speech, comprising:
analyzing the input speech to obtain feature parameter time series by an acoustic analysis section;
developing hypotheses of sub-words by referencing a sub-word state tree formed by placing state sequences of the context dependent acoustic models in a tree structure, a word lexicon describing each of words included in vocabulary in a form of a sub-word network or in a sub-word tree structure, and a language model representing information regarding connection between words, and performing matching between the feature parameter time series and the developed hypotheses so as to generate, as a word lattice, word information including a word, an accumulated score and a beginning start frame with respect to a hypothesis regarding a word end portion, by a matching unit; and
searching the word lattice to generate recognition results by a search unit.

7. A continuous speech recognition program that makes a computer function as the acoustic analysis section, the word lexicon, the language model storage unit, the context dependent acoustic model storage unit, the matching unit and the search unit as recited in claim 1.

8. A program recording medium readable by computer, having the continuous speech recognition program as defined in claim 7 stored therein.
